(19) United States
(12) Patent Application Publication
(10) Pub. No.: US 2013/0107020 A1
(43) Pub. Date: May 2, 2013

(54) IMAGE CAPTURE DEVICE, NON-TRANSITORY COMPUTER-READABLE STORAGE MEDIUM, IMAGE CAPTURE METHOD

(71) Applicant: FUJIFILM Corporation, Tokyo (JP)

(72) Inventor: Takashi HASHIMOTO, Saitama-shi (JP)

(73) Assignee: FUJIFILM Corporation, Tokyo (JP)

(21) Appl. No.: 13/725,813

(22) Filed: Dec. 21, 2012

Related U.S. Application Data
(63) Continuation of application No. PCT/JP2011/059038, filed on Nov. 4, 2011.

(30) Foreign Application Priority Data
Jun. 30, 2010 (JP) 2010-149856

(51) Int. Cl. H04N 13/00

(52) U.S. Cl. CPC H04N 13/0055
USPC 348/50

(57) ABSTRACT

A digital camera measures a distance to a subject when an image has been captured from face-on, and also measures a distance to the subject from a current image capture viewpoint. The digital camera displays a warning when these distances to the subject do not match each other. The digital camera computes a movement distance from an immediately preceding image capture viewpoint to the current image capture viewpoint, and displays a warning when an optimum movement distance between image capture viewpoints has not been reached. 3D image capture can thereby be easily performed from plural image capture viewpoints using a single camera.

### CROSS-REFERENCE TO RELATED APPLICATIONS

This application is a continuation application of International Application No. PCT/JP/2011/059038, filed Apr. 11, 2011, which is incorporated herein by reference. Further, this application claims priority from Japanese Patent Application No. 2010-149856, filed Jun. 30, 2010, which is incorporated herein by reference.

### TECHNICAL FIELD

The present invention relates to an image capture device, a program and an image capture method, and in particular to an image capture device, a program and an image capture method that capture images from plural image capture viewpoints.

### BACKGROUND ART

In a known 3D image capture device for capturing a 3D image of a 3 dimensional object as a subject, plural cameras are disposed along a straight line so as to facilitate angle adjustment (see Japanese Patent Application Laid-Open (JP-A) No. 6-78337).

Also in a known 3D image capture method, image capture of a subject is performed plural times in states of shifted focal distance (see JP-A No. 2002-341473). In this 3D image capture method, images other than the image with the longest focal distance are printed on transparent members, and a 3D image is viewable by holding the transparent members at fixed intervals in sequence from the nearest focal distance.

### DISCLOSURE OF INVENTION

### Technical Problem

However, an issue with the technology disclosed in JP-A No. 6-78337 is that plural cameras need to be provided.

An issue with the technology of JP-A No. 2002-341473 is that printing is required for three dimensional display.

In consideration of the above circumstances, an object of the present invention is to provide an image capture device, a program and an image capture method enabling easy 3D image capture to be performed from plural image capture viewpoints with a single camera.

### Solution to Problem

In order to achieve the above objective, an image capture device of the present invention is configured including: an image capture section that captures an image; an acquisition section that acquires an image capture viewpoint number and an angle of convergence between image capture viewpoints when image capture is to be performed from plural image capture viewpoints; a distance measurement section that, when an image has been captured by the image capture section from a reference image capture viewpoint, measures a distance to a subject in the image captured from the reference image capture viewpoint; and a display controller that, based on the image capture viewpoint number, the angle of convergence between image capture viewpoints, and the distance to the subject, controls to display guidance information on a display section for image display to guide image capture from the plural image capture viewpoints such that the reference image capture viewpoint is positioned at the center of the plural image capture viewpoints.

A program of the present invention is a program that causes a computer to function as: an acquisition section that acquires an image capture viewpoint number and an angle of convergence between image capture viewpoints when image capture is to be performed from plural image capture viewpoints; a distance measurement section that, when an image has been captured from a reference image capture viewpoint by an image capture section for capturing images, measures a distance to a subject in the image captured from the reference image capture viewpoint; and a display controller that, based on the image capture viewpoint number, the angle of convergence between image capture viewpoints, and the distance to the subject, controls to display guidance information on a display section for image display to guide image capture from the plural image capture viewpoints such that the reference image capture viewpoint is positioned at the center of the plural image capture viewpoints.

According to the present invention, the image capture viewpoint number and the angle of convergence between image capture viewpoints when image capture is to be performed from plural image capture viewpoints are acquired by the acquisition section. The image is captured by the image capture section from the reference image capture viewpoint. When this is performed, the distance measurement section measures the distance to the subject in the image captured from the reference image capture viewpoint.

Based on the image capture viewpoint number, the angle of convergence between image capture viewpoints, and the distance to the subject, control is performed by the display controller to display guidance information on the display section for image display to guide image capture from the plural image capture viewpoints such that the reference image capture viewpoint is positioned at the center of the plural image capture viewpoints.

The image capture device and program of the present invention hence easily perform 3D image capture from plural image capture viewpoints with a single camera, by displaying guidance information on the display section to guide image capture from the plural image capture viewpoints such that the reference image capture viewpoint is positioned at the center of the plural image capture viewpoints.

The display controller according to the present invention may be configured to control to display the guidance information on the display section to guide image capture from the plural image capture viewpoints such that the distance to the subject from each of the image capture viewpoints corresponds to the measured distance to the subject.

The distance measurement section according to the present invention may be configured to further measure the distance from a current image capture viewpoint to the subject and, when the distance to the subject from the current image capture viewpoint does not correspond to the measured distance to the subject, to control to display on the display section the guidance information to guide image capture from the plural image capture viewpoints so as to correspond to the measured distance to the subject.

The image capture device according to the present invention may be configured to further include a movement distance computation section that computes the movement distance between image capture viewpoints based on the distance to the subject measured by the distance measurement section and on the angle of convergence between image capture viewpoints, and wherein the display controller controls to display the guidance information on the display section to guide image capture from the plural image capture viewpoints such that a movement distance between image capture viewpoints is the computed movement distance.

Moreover, the image capture device of the present invention including the movement distance computation section may also be configured to further include a current movement distance computation section that computes the movement distance from an immediately preceding image capture viewpoint to a current image capture viewpoint, wherein the display controller, when a movement distance to the current image capture viewpoint computed by the current movement distance computation section does not correspond to the computed movement distance between image capture viewpoints, controls to display the guidance information on the display section to guide image capture from the plural image capture viewpoints such that a movement distance between image capture viewpoints becomes the computed movement distance.

The display controller according to the present invention may be configured to control so as to display the guidance information on the display section to guide image capture such that that after image capture has been performed from the reference image capture viewpoint, image capture is performed from each of the image capture viewpoint(s) positioned more towards either the left hand side or the right hand side than the reference image capture viewpoint with respect to the subject, the image capture device returns to the reference image capture viewpoint, and then image capture is performed from each of the image capture viewpoint(s) positioned more towards the other side out of the left hand side or the right hand side than the reference image capture viewpoint with respect to the subject.

The display controller of the present invention may also be configured to control so as to display the guidance information on the display section to guide such that image capture is performed from an image capture start point derived based on the image capture viewpoint number, the angle of convergence between image capture viewpoints, and the distance to the subject, then image capture is performed from each of the image capture viewpoints gradually approaching the reference image capture viewpoint, and then image capture is performed from each of the image capture viewpoints gradually moving away from the reference image capture viewpoint towards the opposite side to the image capture start point side.

The image capture device according to the present invention may be configured to further include a start point distance computation section that computes a movement distance to the image capture start point based on the image capture viewpoint number, the angle of convergence between image capture viewpoints and the distance to the subject, wherein the display controller controls to display on the display section the computed movement distance to the image capture start point as the guidance information.

The display controller according to the present invention may be configured to display the guidance information so as to be displayed by the display section and superimposed on a real time image captured by the image capture section.

The display controller according to the present invention may be configured to control such that an image that was captured from the immediately preceding image capture viewpoint and has been semi-transparent processed is also displayed on the real time image as the guidance information.

The image capture device according to the present invention may be configured to further include a depth of field adjustment section that, when there are plural subjects present, adjusts a depth of field based on the distances to each of the plural subjects measured by the distance measurement section.

An image capture method according to the present invention includes: acquiring an image capture viewpoint number and an angle of convergence between image capture viewpoints when image capture is to be performed from plural image capture viewpoints; when an image has been captured from a reference image capture viewpoint by an image capture section for capturing images, measuring a distance to a subject in the image captured from the reference image capture viewpoint; and controlling, based on the image capture viewpoint number, the angle of convergence between image capture viewpoints, and the distance to the subject, to display guidance information on a display section for image display to guide image capture from the plural image capture viewpoints such that the reference image capture viewpoint is positioned at the center of the plural image capture viewpoints.

### Advantageous Effects of Invention

As explained above, according to the present invention, the advantageous effect is exhibited of enabling 3D image capture from plural image capture viewpoints to be easily performed with a single camera, by displaying guidance information on the display section to guide image capture from the plural image capture viewpoints such that the reference image capture viewpoint is positioned at the center of the plural image capture viewpoints.

### BRIEF DESCRIPTION OF DRAWINGS

FIG. 1 is a front face perspective view of a digital camera of a first exemplary embodiment of the present invention.

FIG. 2 is a back face perspective view of a digital camera of the first exemplary embodiment of the present invention.

FIG. 3 is a schematic block diagram illustrating an internal configuration of a digital camera according to the first exemplary embodiment of the present invention.

FIG. 4 is a diagram illustrating a manner in which image capture is performed from plural image capture viewpoints in a 3D profile image capture mode.

FIG. 5A is an explanatory diagram of movement distance between image capture viewpoints.

FIG. 5B is an explanatory diagram of movement distance between image capture viewpoints.

FIG. 6A is a diagram illustrating a match in distance to a subject.

FIG. 6B is a diagram illustrating movement distance from an image capture viewpoint.

FIG. 7 is a flow chart illustrating content of a 3D profile image capture processing routine in a first exemplary embodiment.

FIG. 8 is a flow chart illustrating content of a 3D profile image capture processing routine in a first exemplary embodiment.

FIG. 9 is a diagram illustrating a manner in which image capture is performed from plural image capture viewpoints in a 3D profile image capture mode.

FIG. 10 is a flow chart illustrating content of a 3D profile image capture processing routine in a second exemplary embodiment.

FIG. 11 is a flow chart illustrating content of a 3D profile image capture processing routine in a second exemplary embodiment.

FIG. 12 is a schematic block diagram illustrating an internal configuration of a digital camera of a third exemplary embodiment of the present invention.

### BEST MODE FOR CARRYING OUT THE INVENTION

Detailed explanation follows regarding an exemplary embodiment of the present invention, with reference to the drawings. Note that in the present exemplary embodiment a case is explained in which an image capture device of the present invention is applied to a digital camera.

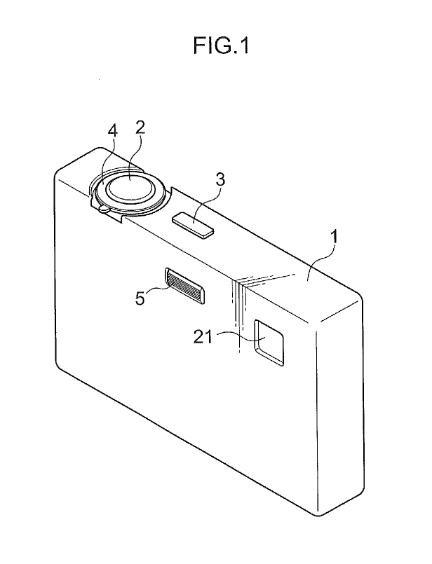

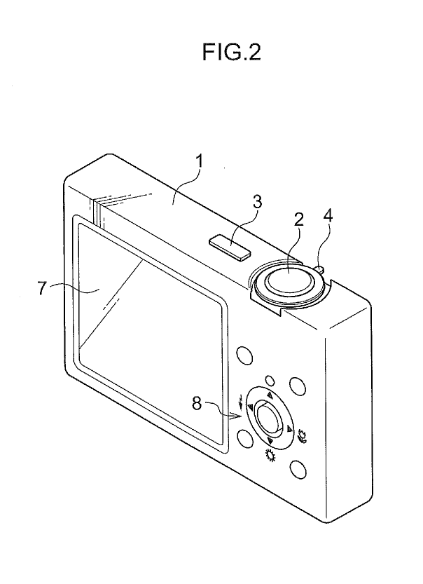

FIG. 1 is a perspective view from the front side of a digital camera 1 of a first exemplary embodiment, and FIG. 2 is a perspective view from the back side. As illustrated in FIG. 1, an upper portion of the digital camera 1 is equipped with a release button 2, a power supply button 3 and a zoom lever 4. A flash 5 and a lens of an image capture section 21 are disposed on the front face of the digital camera 1. A liquid crystal monitor 7 that performs various displays and various operation buttons 8 are disposed on the back face of the digital camera 1.

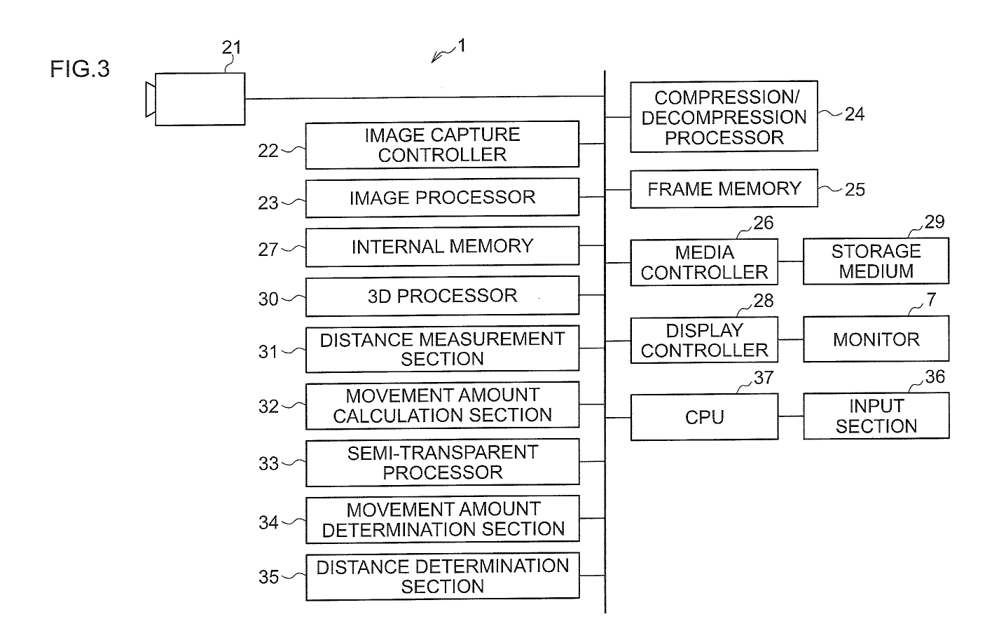

FIG. 3 is a schematic block diagram illustrating an internal configuration of the digital camera 1. As illustrated in FIG. 3, the digital camera 1 is equipped with the image capture section 21, an image capture controller 22, an image processor 23, a compression/decompression processor 24, a frame memory 25, a media controller 26, an internal memory 27, a display controller 28, an input section 36 and a CPU 37.

The image capture controller 22 is configured with an AF processor and an AE processor, not illustrated in the drawings. The AF processor determines the subject region as the focal region based on a pre-image captured by the image capture section by pressing the release button 2 halfway, determines the lens focal position, and outputs the determinations to the image capture section 21. Note that the subject region is identified by a known image recognition processing technique. The AE processor determines the aperture number and shutter speed based on the pre-image and outputs the determination to the image capture section 21.

The image capture controller 22 is operated by pressing the release button 2 fully, and issues a main image capture instruction to the image capture section 21 to acquire a main image of the image. Prior to operation of the release button 2, the image capture controller 22 instructs the image capture section 21 to acquire at specific time intervals (for example at intervals of 1/30 second) a sequence of real time images with fewer numbers of pixels than the main image in order to confirm the image capture region.

The image processor 23 performs image processing such as white balance adjustment processing, shading correction, sharpness correction and color correction on digital image data of images acquired by the image capture section 21.

The compression/decompression processor 24 performs compression processing with a compression format such as, for example, JPEG on image data expressing an image that has been processed by the image processor 23, and generates an image file. The image file includes image data of an image. The image file is stored with ancillary data in for example an Exif format for such items as base line length, angle of convergence, image capture time, and viewpoint data expressing viewpoints positions in a 3D profile image capture mode, described later.

The frame memory 25 is a working memory employed when performing various types of processing including processing performed by the image processor 23 on the image data expressing an image acquired by the image capture section 21.

The media controller 26 controls access to a storage medium 29 and for example writing and reading of image files.

The internal memory 27 is stored with items such as various constants set in the digital camera 1 and a program executed by the CPU 37.

During imaging the display controller 28 displays images stored in the frame memory 25 on the liquid crystal monitor 7, and the display controller 28 also displays images that have been stored on the storage medium 29 on the liquid crystal monitor 7. The display controller 28 displays real time images on the liquid crystal monitor 7.

In the 3D profile image capture mode, the display controller 28 displays guidance on the liquid crystal monitor 7 for capturing a subject from plural viewpoints.

In the present exemplary embodiment, the digital camera 1 is equipped with the 3D profile image capture mode for acquiring image data captured from plural image capture viewpoints in order to measure the 3D profile of an identified image subject.

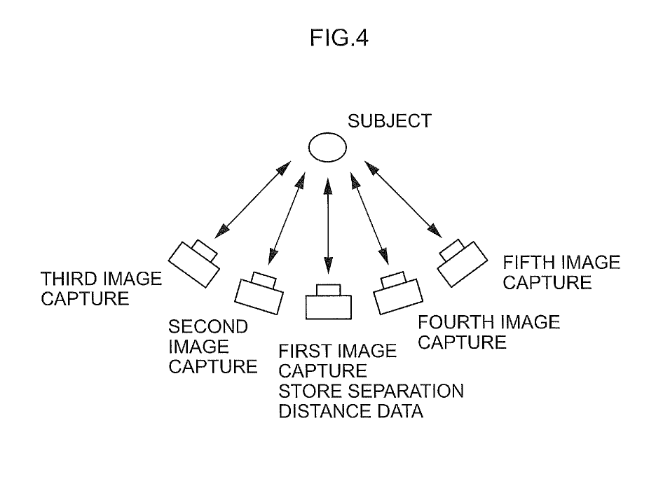

In the 3D profile image capture mode, as illustrated in FIG. 4, a photographer moves along a circular arc path with the identified subject at the center, and captures images of the subject with the digital camera 1 from plural image capture viewpoints, with an image capture viewpoint for capturing a face-on image of the identified subject at the center, and at least one image capture viewpoint on the left and on the right thereof. Note that the image capture viewpoint for capturing the face-on image of the subject corresponds to the reference image capture viewpoint.

The digital camera 1 is equipped with a 3D processor 30, a distance measurement section 31, a movement amount calculation section 32, a semi-transparent processor 33, a movement amount determination section 34 and a distance determination section 35. Note that the movement amount determination section 34 is an example of a current movement distance computation section.

The 3D processor 30 performs 3D processing on the plural images captured at the plural image capture viewpoints and generates a 3D image therefrom.

The distance measurement section 31 measures the distance to a subject based on the lens focal position for the subject region obtained by the AF processor of the image capture controller 22. In the 3D profile image capture mode, the distance to the subject measured when capturing a face-on image is stored in memory as a reference distance.

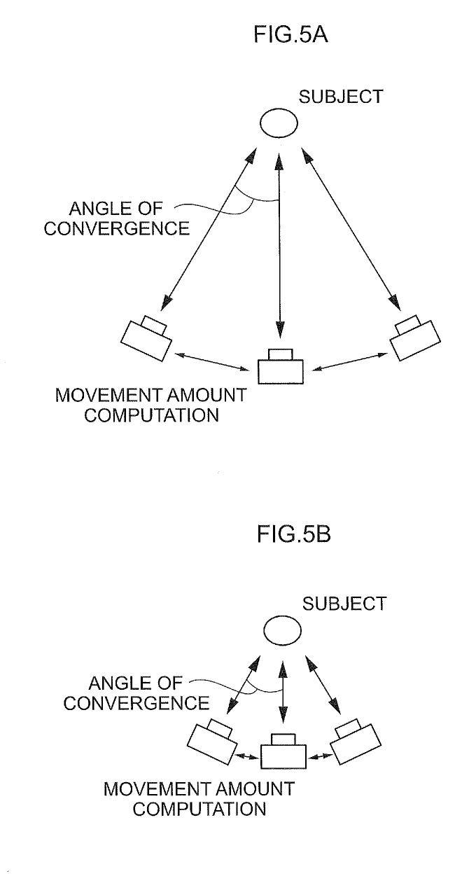

The movement amount calculation section 32, as illustrated in FIG. 5A and FIG. 5B, calculates the optimum movement distance between the plural image capture viewpoints for when imaging in the 3D profile image capture mode, based on the distance to the subject measured by the distance measurement section 31 and the angle of convergence between the image capture viewpoints. Note that the angle of convergence between image capture viewpoints may be derived in advance and set as a parameter.

The semi-transparent processor 33 performs semi-transparent processing on images captured in the 3D profile image capture mode.

In the 3D profile image capture mode, the movement amount determination section 34 computes the movement distance from the immediately preceding image capture viewpoint, and determines whether or not the computed movement distance has reached the optimum movement distance between image capture viewpoints.

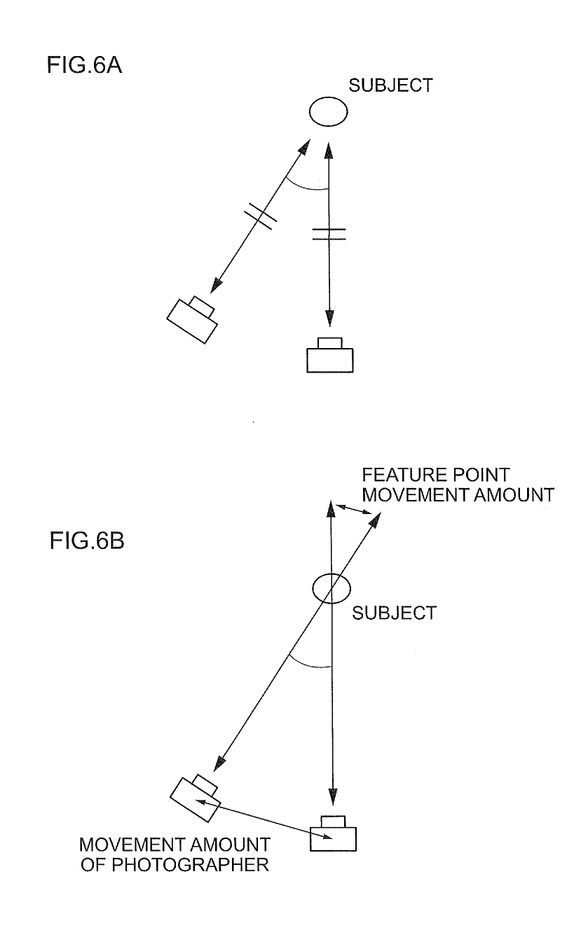

For example, the movement amount determination section 34 extracts feature points from the subject in the image captured from the immediately preceding image capture viewpoint and in the current real time image, and associates corresponding feature points with each other, and computes the movement amount between the feature points in the images. The movement amount determination section 34 also computes the movement distance from the immediately preceding image capture viewpoint to the current image capture viewpoint based the computed movement amount between feature points, as illustrated in FIG. 6B, and on the distance to the subject.

In the 3D profile image capture mode, the distance determination section 35, as illustrated in FIG. 6A, employs the distance to the subject from the current image capture viewpoint and the distance to the subject when a face-on image is captured, respectively measured by the distance measurement section 31, to determine whether or not the distances to the subject match. Note that a match of the distances to the subject is not limited to a complete match of the distances to the subject. Configuration may be made such that a permissible range of comparison error is set for distance to the subject.

In the 3D profile image capture mode, when determination by the movement amount determination section 34 is affirmative and determination by the distance determination section 35 is affirmative, image capture permission is input to the image capture controller 22. In this state, operation to press the release button 2 down fully results in a main image capture instruction to the image capture section 21 to acquire a main image as the image.

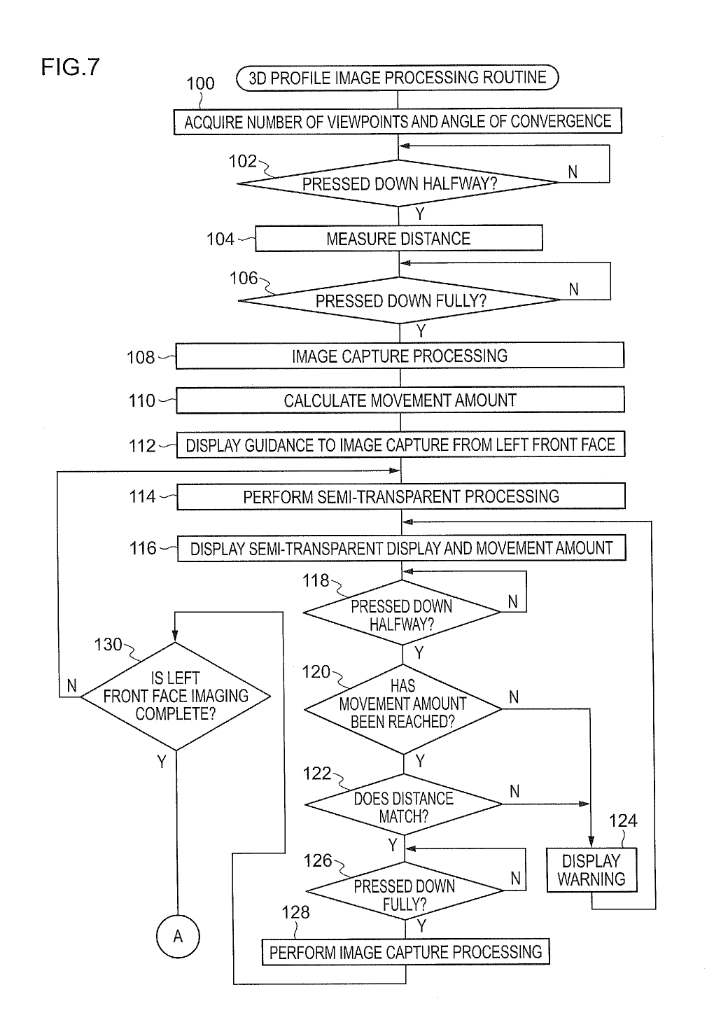

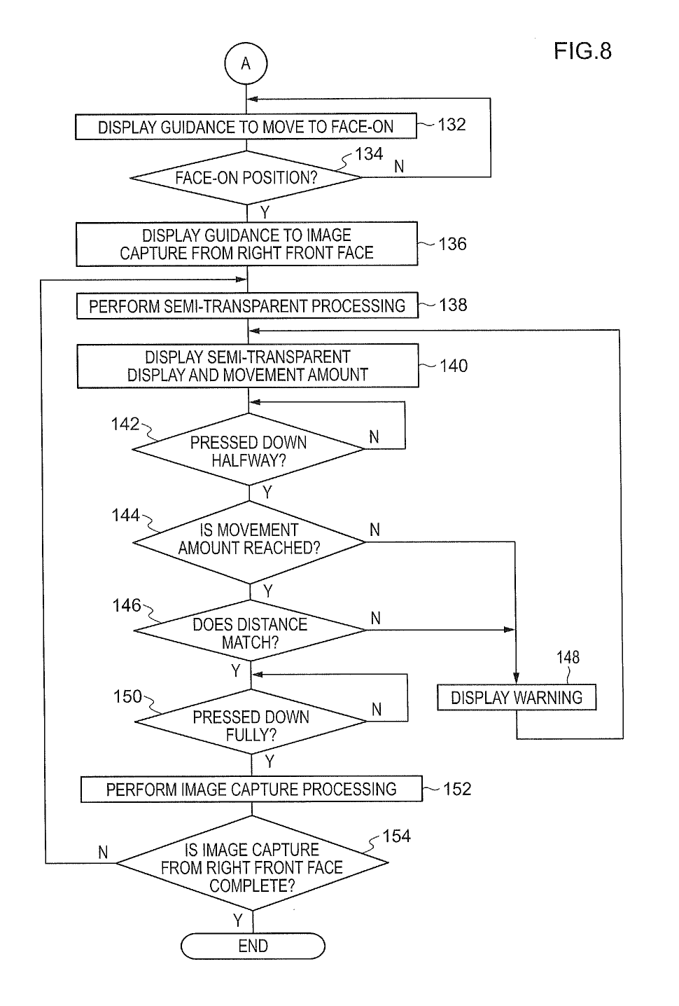

Explanation follows regarding a 3D profile image capture processing routine of the digital camera 1 of the first exemplary embodiment, with reference to FIG. 7 and FIG. 8.

At step 100, the digital camera 1 acquires an image capture viewpoint number and an angle of convergence between image capture viewpoints that have been set in advance. Then at step 102, the digital camera 1 determines whether or not the release button 2 has been pressed down halfway. Processing proceeds to step 104 when the release button 2 has been operated and pressed down halfway by a user. In such cases the lens focal position is determined by the AF processor of the image capture controller 22 and the aperture and shutter speed are determined by the AE processor.

At step 104, the digital camera 1 acquires the lens focal position for the subject region determined by the AF processor, calculates the distance to the subject, and stores this distance as a reference distance to the subject in the internal memory 27.

Then at step 106, the digital camera 1 determines whether or not the release button 2 has been pressed down fully. Processing proceeds to step 108 when the release button 2 has been operated and pressed down fully by the user.

At step 108 the digital camera 1 issues a main image capture instruction to the image capture section 21 to acquire a main image of the image. An image is acquired with the image capture section 21 and stored as a face-on image in the storage medium 29.

Then at step 110, the digital camera 1 calculates the optimum movement distance between image capture viewpoints based on the angle of convergence between image capture viewpoints acquired at step 100 and the distance to the subject measured at step 104, and stores the optimum movement distance in the internal memory 27. Then at step 112, the digital camera 1 displays a guidance message on the liquid crystal monitor 7 to “please image capture from the left front face”.

At step 114, the digital camera 1 performs semi-transparent processing on the image captured at step 108 or at step 128 the previous time. At step 116, the digital camera 1 displays the movement distance between image capture viewpoints calculated at step 110 and the semi-transparent processed image, displayed on the liquid crystal monitor 7 superimposed on the real time image.

At the next step 118, the digital camera 1 determines whether or not the release button 2 has been pressed down halfway. Processing proceeds to step 120 when the release button 2 has been operated and pressed down halfway by the user. Then the lens focal position is determined by the AF processor of the image capture controller 22 and the aperture and shutter speed are determined by the AE processor.

At step 120, the digital camera 1 computes the movement distance from the immediately preceding image capture viewpoint to the current image capture viewpoint based on the image captured at step 108 or the previous time at step 128 and on the current real time image, and determines whether or not the optimum movement distance between image capture viewpoints calculated at step 110 has been reached. Processing transitions to step 124 when the optimum movement distance has not been reached. When the optimum movement distance has been reached, at step 122 the digital camera 1 calculates the distance to the subject from the current image capture viewpoint based on the lens focal position for the subject region determined by the AF processor. Then the digital camera 1 determines whether or not there is a match to the reference distance to the subject measured at step 104. Processing transitions to step 124 when there is no match to the reference distance to the subject. However, when there is match to the reference distance to the subject, the digital camera 1 inputs image capture permission to the image capture controller 22 and processing transitions to step 126.

At step 124 the digital camera 1 displays a warning message “movement distance between image capture viewpoints not matched” or a warning message “reference distance to the subject not matched” on the liquid crystal monitor 7, and then processing returns to step 116.

At step 126, the digital camera 1 determines whether or not the release button 2 has been pressed down fully. Processing proceeds to step 128 when the release button 2 has been operated and pressed down fully by a user.

At step 128, the digital camera 1 issues a main image capture instruction to the image capture section 21 to acquire a main image of the image, an image is acquired by the image capture section 21 and stored in the storage medium 29 as a left front face image.

At the next step 130, the digital camera 1 determines whether or not imaging from the left front face has been completed. In cases in which the required image capture viewpoint number from the left front face (for example 2), determined from the image capture viewpoint number acquired at step 100 (for example 5), have been captured by step 128, the digital camera 1 determines that imaging from the left front face has been completed and processing transitions to step 132. However, processing returns to step 114 when image capture from the left front face has not yet been performed for the required image capture viewpoint number.

At step 132, the digital camera 1 displays the guidance message “please return to face-on” on the liquid crystal monitor 7. At the next step 134 the digital camera 1 determines whether or not the current image capture viewpoint is the face-on position. For example, the digital camera 1 performs threshold value determination of edges on the current real time image and the face-on image captured at step 108, and determines whether or not the current image capture viewpoint is at the face-on position. Processing returns to step 132 when it is determined not to be the face-on position, and processing transitions to step 136 when it is determined to be the face-on position.

At step 136, the digital camera 1 displays the guidance message “please image capture from the right front face” on the liquid crystal monitor 7.

At step 138, the digital camera 1 performs semi-transparent processing on the image captured at step 108 or the image captured at step 152 the previous time. At step 140, the digital camera 1 displays the movement distance between the image capture viewpoints computed at step 110 and the semi-transparent processed image, superimposed on the real time image on the liquid crystal monitor 7.

At step 142, the digital camera 1 determines whether or not the release button 2 has been pressed down halfway. Processing proceeds to step 144 when the release button 2 has been operated by a user and pressed down halfway. When this occurs, the lens focal position is determined by the AF processor of the image capture controller 22 and the aperture and shutter speed are determined by the AE processor.

At step 144, the digital camera 1 computes the movement distance from the immediately preceding image capture viewpoint to the current image capture viewpoint based on the image captured at step 108 or at step 152 the previous time and on the current real time image, and determines whether or not the optimum movement distance between image capture viewpoints calculated at step 110 has been reached. Processing transitions to step 148 when the optimum movement distance has not been reached. When the optimum movement distance has been reached, at step 146 the digital camera 1 calculates the distance to the subject from the current image capture viewpoint, similarly to in step 122. Then the digital camera 1 determines whether or not this distance matches the reference distance to the subject measured at step 104. Processing transitions to step 148 when the reference distance to the subject is not matched. However, when the reference distance to the subject is matched, processing transitions to step 150 and the digital camera 1 inputs image capture permission to the image capture controller 22.

At step 148, the digital camera 1 displays a warning message “movement distance between viewpoints not reached” or a warning message “reference distance to subject not matched” on the liquid crystal monitor 7, and processing returns to step 140.

At step 150, the digital camera 1 determines whether or not the release button 2 has been pressed down fully. Processing proceeds to step 152 when the release button 2 has been operated by a user and pressed down fully.

At step 152, the digital camera 1 issues a main image capture instruction to the image capture section 21 to acquire a main image of the image, an image captured by the image capture section 21 is acquired and stored in the storage medium 29 as a right front face image.

Next at step 154 the digital camera 1 determines whether or not image capture from the right front face is complete. In cases in which the required image capture viewpoint number from the right front face (for example 2), determined from the image capture viewpoint number acquired at step 100 (for example 5), have been captured by image capture at step 152, the digital camera 1 determines that imaging from the right front face has been completed, thereby completing the 3D profile image capture processing routine. However, processing returns to step 138 when image capture from the right front face has not yet been performed the required image capture viewpoint number from the right front face.

The plural images captured from the plural image capture viewpoints obtained by the above 3D profile image capture processing routine are stored on the storage medium 29 as a multi-viewpoint image.

Note that in the above exemplary embodiment an explanation has been given of an example in which the image capture viewpoint number is an odd number. However, when the image capture viewpoint number is an even number, configuration may be made such that the digital camera 1 does not count the image capture of the face-on image at step 108 in the image capture viewpoint number. In such cases, processing may be performed with ½ the optimum movement distance between image capture viewpoints as the movement distance for the first time of step 116, step 120, step 140 and step 144. The face-on image also does not configure part of the multi-viewpoint image.

As explained above, the digital camera 1 of the first exemplary embodiment enables easy image capture to be performed from plural viewpoints for 3D profile measurement with a single camera by displaying guidance to guide image capture from plural image capture viewpoints, such that the image capture viewpoint that captured a face-on image is at the overall center position out of the image capture viewpoints.

Moreover, a 3D profile cannot be accurately measured when there is variation in the size of the subject between images captured from multiple viewpoints. However, in the present exemplary embodiment, the sizes of the subject can be made to match by the digital camera 1 displaying guidance to match the distance to the subject.

Moreover, the digital camera 1 displays guidance such that the movement distance between image capture viewpoints is the movement distance derived from angles of convergence, and so missing data does not occur when reproducing the 3D profile due to mistakes in image capture angles (variation in the movement distance between image capture viewpoints).

Explanation follows regarding a second exemplary embodiment. Since the configuration of a digital camera according to the second exemplary embodiment is similar to the digital camera 1 of the first exemplary embodiment, the same reference numerals are appended and further explanation is omitted.

In the second exemplary embodiment, a digital camera 1 differs from the first exemplary embodiment in that in a 3D profile image capture mode, images are captured from plural image capture viewpoints such that the image capture viewpoint is moved from an image capture viewpoint at the maximum angle on the right front face or the left front face towards the direction face on to the subject.

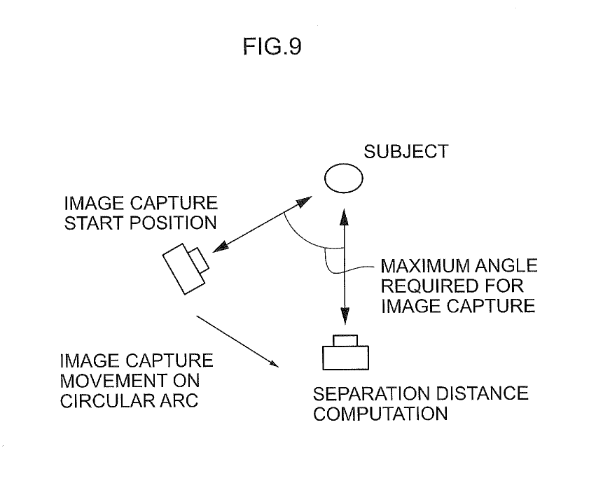

In the digital camera 1 according to the second exemplary embodiment, in the 3D profile image capture mode, as illustrated in FIG. 9, image capture is performed for a face-on image as preparatory image capture, an image capture viewpoint out of plural image capture viewpoints with the maximum required angle for image capture relative to face-on to the subject is employed as the image capture start position, and the image capture viewpoint is moved along a circular arc path towards the face-on position to the subject. Then, with the image capture viewpoint out of plural image capture viewpoints with the maximum required angle for image capture relative to face-on to the subject on the opposite side for image capture as an image capture final position, the image capture viewpoint is moved through the face-on position to the subject and on through image capture viewpoints along a circular arc path towards the image capture final position.

When image capture is to be performed in the 3D profile image capture mode, the movement amount calculation section 32 calculates the optimum movement distance between plural image capture viewpoints. Based on the distance to the subject measured by the distance measurement section 31, the angle of convergence between image capture viewpoints, and the image capture viewpoint number required from the left front face or the right front face determined from the image capture viewpoint number, the movement amount calculation section 32 calculates the movement distance from the face-on image capture viewpoint where preparatory image capture was performed to the image capture start position. Note that the movement amount calculation section 32 is an example of a movement distance computation section and a start point distance computation section.

In the 3D profile image capture mode, the movement amount determination section 34 computes the movement distance from the face-on image capture viewpoint where the preparatory image was captured, and determines whether or not the computed movement distance has reached the movement distance to the image capture start position calculated by the movement amount calculation section 32.

In the 3D profile image capture mode, the movement amount determination section 34 computes the movement distance from the immediately preceding image capture viewpoint, and determines whether or not the computed movement distance has reached the optimum movement distance between image capture viewpoints.

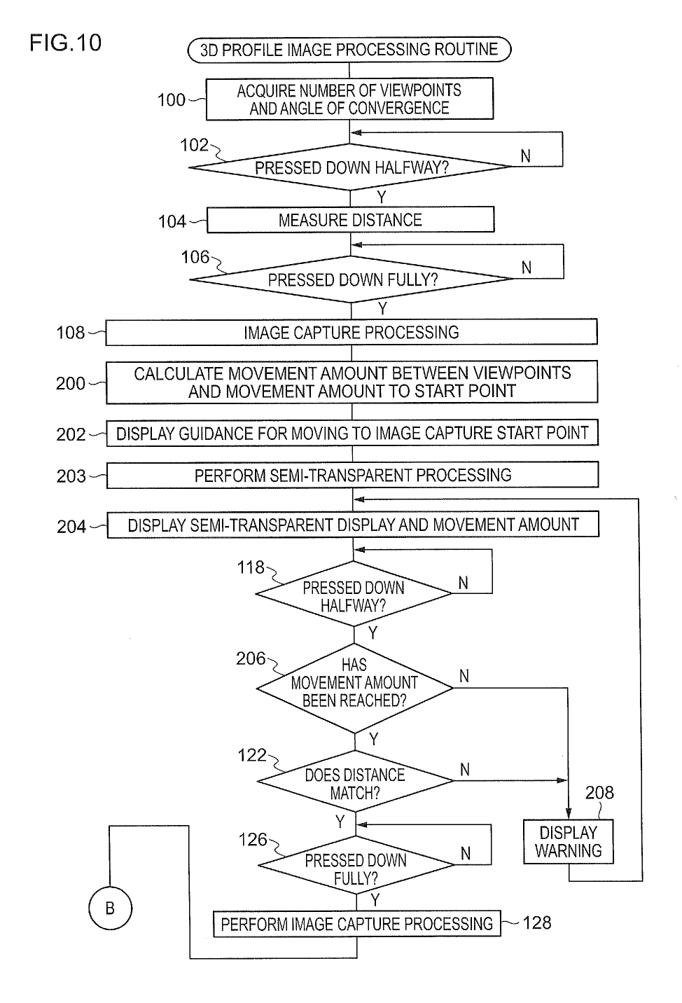

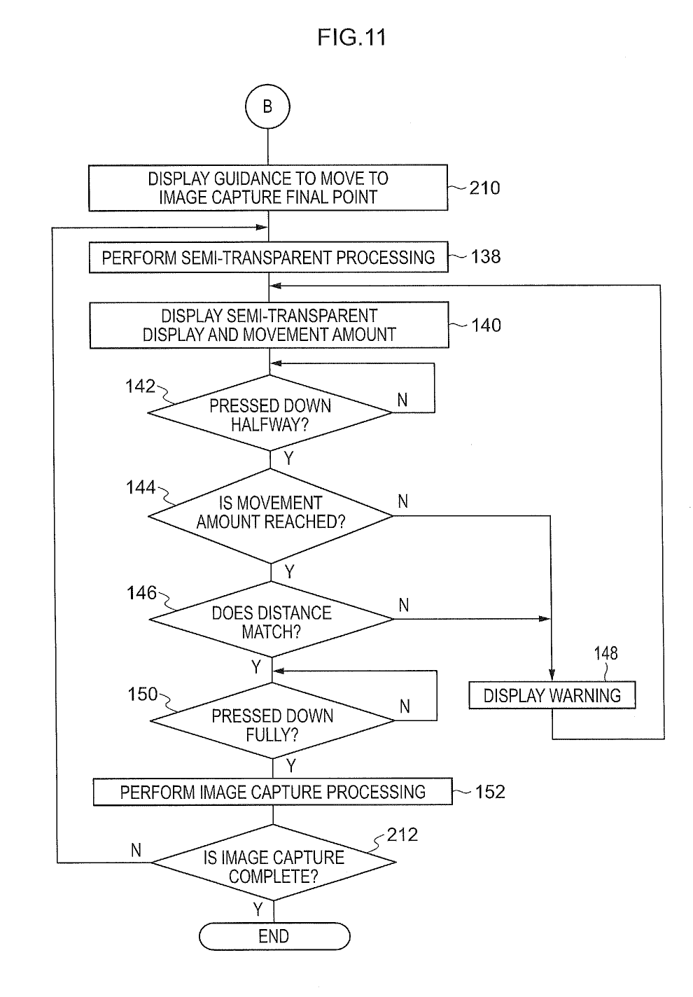

Explanation follows regarding a 3D profile image capture processing routine in the digital camera 1 according to the second exemplary embodiment, with reference to FIG. 10 and FIG. 11. Note that the same reference numerals are appended to similar processing to that of the 3D profile image capture processing routine of the first exemplary embodiment, and further explanation is omitted thereof.

At step 100, the digital camera 1 acquires an image capture viewpoint number and an angle of convergence between image capture viewpoints that have been set in advance. Then at step 102, the digital camera 1 determines whether or not the release button 2 has been pressed down halfway. Processing proceeds to step 104 when the release button 2 has been operated and pressed down halfway by a user.

At step 104, the digital camera 1 acquires the lens focal position for the subject region determined by the AF processor, calculates the distance to the subject, and stores this distance as a reference distance to the subject in the internal memory 27.

Then at step 106, the digital camera 1 determines whether or not the release button 2 has been pressed down fully. Processing proceeds to step 108 when the release button 2 has been operated and pressed down fully by the user.

At step 108 the digital camera 1 issues a main image capture instruction to the image capture section 21 to acquire a main image of the image. An image is acquired with the image capture section 21 and stored as a preparatory captured face-on image on the storage medium 29.

Then at step 200, based on the angle of convergence between image capture viewpoints acquired at step 100 and the distance to the subject measured at step 104, the digital camera 1 calculates the optimum movement distance between image capture viewpoints and stores the optimum movement distance in the internal memory 27. Based on the image capture viewpoint number and the angle of convergence between image capture viewpoints acquired at step 100, and on the distance to the subject measured at step 104, the digital camera 1 then calculates the movement distance to the image capture start point and stores the calculated movement distance in the internal memory 27.

At the next step 202, the digital camera 1 displays a guidance message “please move to the left front face image capture start point” on the liquid crystal monitor 7.

Then at step 203, the digital camera 1 performs semi-transparent processing on the image captured at step 108. At step 204 the digital camera 1 displays the movement distance to the image capture start point calculated at step 110 and the semi-transparent processed image on the liquid crystal monitor 7, superimposed on the real time image.

At the next step 118, the digital camera 1 determines whether or not the release button 2 has been pressed down halfway. When the release button 2 has been operated and pressed down halfway by a user, at step 206 the digital camera 1, based on the image captured at step 108 and the current real time image, computes the movement distance from the image capture viewpoint where the face-on image was captured at step 108 to the current image capture viewpoint. The digital camera 1 then determines whether or not the computed movement distance has reached the movement distance to the image capture start point computed at step 200. Processing transitions to step 208 when the computed movement distance has not reached the movement distance to the image capture start point. When the computed movement distance has reached the movement distance to the image capture start point, at step 122 the digital camera 1 measures the distance to the subject from the current image capture viewpoint. The digital camera 1 then determines whether or not this matches the reference distance to the subject measured at step 104. Processing transitions to step 208 when there is no match to the reference distance to the subject. However, when there is a match to the reference distance to the subject the digital camera 1 inputs image capture permission to the image capture controller 22 and processing transitions to step 126.

At step 208, the digital camera 1 displays a warning message “movement distance to the image capture start point not reached” or the warning message “reference distance to the subject not matched” on the liquid crystal monitor 7, and processing returns to step 204.

At step 126 the digital camera 1 determines whether or not the release button 2 has been pressed down fully. Processing proceeds to step 128 when the release button 2 has been operated and pressed down fully by a user.

At step 128, the digital camera 1 issues main image capture instruction to the image capture section 21 to acquire a main image of the image, an image is captured with the image capture section 21, and this image is stored in the storage medium 29 as a left front face image from the image capture start point.

Then at step 210, the digital camera 1 displays the guidance message “please move to the image capture final point” on the liquid crystal monitor 7. Then at step 138 the digital camera 1 performs semi-transparent processing on the image captured at step 128 or captured at step 152 the previous time. At step 140 the digital camera 1 displays the movement distance between image capture viewpoints calculated at step 200 and the semi-transparent processed image on the liquid crystal monitor 7, superimposed on the real time image.

Then at step 142, the digital camera 1 determines whether or not the release button 2 has been pressed down halfway. When the release button 2 has been operated and pressed down halfway by a user, at step 144 the movement distance from the immediately preceding image capture viewpoint to the current image capture viewpoint is computed, based on the image captured at step 128 or captured at step 152 the previous time and on the current real time image. Then the digital camera 1 determines whether or not the computed movement distance has reached the optimum movement distance between image capture viewpoints calculated at step 200. Processing transitions to step 148 when the computed movement distance has not reached the optimum movement distance between image capture viewpoints. When the computed movement distance has reached the optimum movement distance between image capture viewpoints, at step 146 the digital camera 1 measures the distance to the subject from the current image capture viewpoint, similarly to in step 122. The digital camera 1 then determines whether or not the measured distance matches the reference distance to the subject measured at step 104. Processing transitions to step 148 when the reference distance to the subject is not matched. However, when the reference distance to the subject is matched, the digital camera 1 inputs image capture permission to the image capture controller 22 and processing transitions to step 150.

At step 148, the digital camera 1 displays the warning message “movement distance between image capture viewpoints not reached” or the warning message “reference distance to the subject not matched” on the liquid crystal monitor 7 and processing returns to step 140.

At step 150 the digital camera 1 determines whether or not the release button 2 has been pressed down fully. Processing proceeds to step 152 when the release button 2 has been operated and pressed down fully by a user.

At step 152 the digital camera 1 issues main image capture instruction to the image capture section 21 to acquire a main image of the image, an image captured by the image capture section 21 is acquired and stored in the storage medium 29.

At the next step 212, the digital camera 1 determines whether or not image capture has been completed from all image capture viewpoints. When the number of images captured at step 128 and step 152 are the image capture viewpoint number acquired at step 100, the digital camera 1 determines that image capture from all the image capture viewpoints is complete and ends the 3D profile image capture processing routine. However, processing returns to step 138 when image capture has not been performed for the acquired image capture viewpoint number.

As explained above, the digital camera 1 of the second exemplary embodiment enables easy image capture to be performed from plural viewpoints for 3D profile measurement with a single camera by displaying guidance to guide image capture from plural image capture viewpoints, such that the image capture viewpoint where the preparatory face-on image was captured is at the overall center of the image capture viewpoints.

Explanation follows regarding a third exemplary embodiment. Features similar to the configuration of the digital camera 1 of the first exemplary embodiment are allocated the same reference numerals and further explanation is omitted.

The third exemplary embodiment differs from the first exemplary embodiment in the point that when there are plural subjects present, a digital camera 1 adjusts the depth of field according to the distances to the respective subjects.

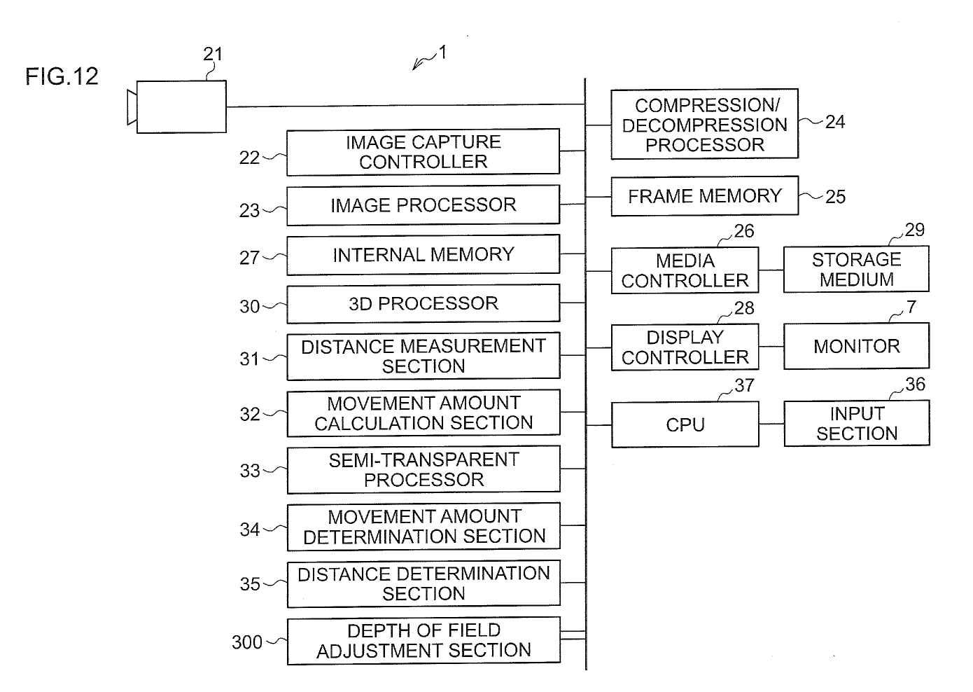

As illustrated in FIG. 12, in the digital camera 1 according to the third exemplary embodiment, when there are plural subjects present, a AF processor of an image capture controller 22 determines respective focal regions for each of the subject regions based on pre-images acquired by an image capture section when a release button 2 is pressed down halfway. The AF processor also determines the lens focal position for each of the focal regions and outputs these positions to an image capture section 21.

A distance measurement section 31 measures the distance to each of the subjects based on the lens focal position for each of the subject regions obtained by the AF processor of the image capture controller 22. In a 3D profile image capture mode, the distance measurement section 31 takes an average distance of the distances to each of the subjects measured when a face-on image is captured and stores the average distance in memory as a reference distance.

When there are plural subjects present in the 3D profile image capture mode, a distance determination section 35 compares an average distance to each of the subjects from the current image capture viewpoint measured by the distance measurement section 31 against the average distance to each of the subjects when the face-on image was captured, and determines whether or not the distances to the subjects match.

The digital camera 1 is further equipped with a depth of field adjustment section 300. When there are plural subjects present, the depth of field adjustment section 300 adjusts the depth of field such that all of the subjects are in focus based on the distance to each of the subjects. For example, the depth of field adjustment section 300 adjusts the depth of field by adjusting aperture and shutter speed.

In the 3D profile image capture mode, the depth of field adjustment section 300 adjusts the depth of field such that all the subjects are in focus based on the distances to the subjects measured when the face-on image was captured.

Note that other parts of the configuration and operation of the digital camera 1 according to the third exemplary embodiment are similar to those of the first exemplary embodiment and so further explanation is omitted.

When there are plural subjects present, the digital camera 1 is thus able to image capture such that all the subjects are in focus rather than just concentrating on focusing a single point.

Note that in the first exemplary embodiment to the third exemplary embodiment explanation has been given of examples of cases in which the image capture viewpoint number and the angle of convergence between image capture viewpoints are set in advance, however there is no limitation thereto. Configuration may be made such that the image capture viewpoint number and the angle of convergence between image capture viewpoints are set by user input.

Explanation has been given of examples of cases in which the optimum movement distance between image capture viewpoints is displayed superimposed on real time images, however there is no limitation thereto. The digital camera 1 may be configured to display a difference between the current movement distance from the immediately preceding image capture viewpoint and the optimum movement distance between image capture viewpoints, superimposed on real time images. The digital camera 1 may also be configured to display the current movement distance from the immediately preceding image capture viewpoint, superimposed on real time images.

The 3D profile image capture processing routines of the first exemplary embodiment to the third exemplary embodiment may also be converted into programs, and these programs executed by a CPU.

A computer readable storage medium according to the present invention is stored with a program that causes a computer to function as: an acquisition section that acquires an image capture viewpoint number and an angle of convergence between image capture viewpoints when image capture is to be performed from plural image capture viewpoints; a distance measurement section that, when an image has been captured from a reference image capture viewpoint by an image capture section for capturing images, measures a distance to a subject in the image captured from the reference image capture viewpoint; and a display controller that, based on the image capture viewpoint number, the angle of convergence between image capture viewpoints and the distance to the subject, controls to display guidance information on a display section for image display to guide image capture from the plural image capture viewpoints such that the reference image capture viewpoint is positioned at the center of the plural image capture viewpoints.

The content disclosed in Japanese Patent Application Number 2010-149856 is incorporated in its entirety in the present specification.

All cited documents, patent applications and technical standards mentioned in the present specification are incorporated by reference in the present specification to the same extent as if the individual cited documents, patent applications and technical standards were specifically and individually incorporated by reference in the present specification.

1. An image capture device comprising:
an image capture section that captures an image;
an acquisition section that acquires an image capture viewpoint number and an angle of convergence between image capture viewpoints when image capture is to be performed from a plurality of image capture viewpoints;
a distance measurement section that, when an image has been captured by the image capture section from a reference image capture viewpoint, measures a distance to a subject in the image captured from the reference image capture viewpoint; and
a display controller that, based on the image capture viewpoint number, the angle of convergence between image capture viewpoints, and the distance to the subject, controls to display guidance information on a display section for image display to guide image capture from the plurality of image capture viewpoints such that the reference image capture viewpoint is positioned at the center of the plurality of image capture viewpoints.

2. The image capture device of claim 1, wherein the display controller controls to display the guidance information on the display section to guide image capture from the plurality of image capture viewpoints such that the distance to the subject from each of the image capture viewpoints corresponds to the measured distance to the subject.

3. The image capture device of claim 2, wherein:
the distance measurement section further measures the distance from a current image capture viewpoint to the subject and, when the distance to the subject from the current image capture viewpoint does not correspond to the measured distance to the subject, controls to display on the display section the guidance information to guide image capture from the plurality of image capture viewpoints so as to correspond to the measured distance to the subject.

4. The image capture device of claim 1, wherein:
the image capture device further comprises a movement distance computation section that computes the movement distance between image capture viewpoints based on the distance to the subject measured by the distance measurement section and on the angle of convergence between image capture viewpoints; and
the display controller controls to display the guidance information on the display section to guide image capture from the plurality of image capture viewpoints such that a movement distance between image capture viewpoints is the computed movement distance.

5. The image capture device of claim 4, wherein:
the image capture device further comprises a current movement distance computation section that computes the movement distance from an immediately preceding image capture viewpoint to a current image capture viewpoint; and
the display controller, when a movement distance to the current image capture viewpoint computed by the current movement distance computation section does not correspond to the computed movement distance between image capture viewpoints, controls to display the guidance information on the display section to guide image capture from the plurality of image capture viewpoints such that a movement distance between image capture viewpoints becomes the computed movement distance.

6. The image capture device of claim 1, wherein the display controller controls to display the guidance information on the display section to guide image capture such that that after image capture has been performed from the reference image capture viewpoint, image capture is performed from each of the image capture viewpoint(s) positioned more towards either the left hand side or the right hand side than the reference image capture viewpoint with respect to the subject, the image capture device returns to the reference image capture viewpoint, and then image capture is performed from each of the image capture viewpoint(s) positioned more towards the other side out of the left hand side or the right hand side than the reference image capture viewpoint with respect to the subject.

7. The image capture device of claim 1, wherein the display controller controls so as to display the guidance information on the display section to guide such that image capture is performed from an image capture start point derived based on the image capture viewpoint number, the angle of convergence between image capture viewpoints, and the distance to the subject, then image capture is performed from each of the image capture viewpoints gradually approaching the reference image capture viewpoint, and then image capture is performed from each of the image capture viewpoints gradually moving away from the reference image capture viewpoint towards the opposite side to the image capture start point side.

8. The image capture device of claim 7, wherein:
the image capture device further comprises a start point distance computation section that computes a movement distance to the image capture start point based on the image capture viewpoint number, the angle of convergence between image capture viewpoints and the distance to the subject; and
the display controller controls to display on the display section the computed movement distance to the image capture start point as the guidance information.

9. The image capture device of claim 1, wherein the display controller displays the guidance information so as to be displayed by the display section and superimposed on a real time image captured by the image capture section.

10. The image capture device of claim 9, wherein the display controller controls such that an image that was captured from the immediately preceding image capture viewpoint and has been semi-transparent processed is also displayed on the real time image as the guidance information.

11. The image capture device of claim 1, further comprising a depth of field adjustment section that, when there is a plurality of subjects present, adjusts a depth of field based on the distances to each of the plurality of subjects measured by the distance measurement section.

12. A non-transitory computer-readable storage medium that stores a program that causes a computer to function as:
an acquisition section that acquires an image capture viewpoint number and an angle of convergence between image capture viewpoints when image capture is to be performed from a plurality of image capture viewpoints;
a distance measurement section that, when an image has been captured from a reference image capture viewpoint by an image capture section for capturing images, measures a distance to a subject in the image captured from the reference image capture viewpoint; and
a display controller that, based on the image capture viewpoint number, the angle of convergence between image capture viewpoints, and the distance to the subject, controls to display guidance information on a display section for image display to guide image capture from the plurality of image capture viewpoints such that the reference image capture viewpoint is positioned at the center of the plurality of image capture viewpoints.

13. An image capture method comprising:
acquiring an image capture viewpoint number and an angle of convergence between image capture viewpoints when image capture is to be performed from a plurality of image capture viewpoints;
when an image has been captured from a reference image capture viewpoint by an image capture section for capturing images, measuring a distance to a subject in the image captured from the reference image capture viewpoint; and
controlling, based on the image capture viewpoint number, the angle of convergence between image capture viewpoints, and the distance to the subject, to display guidance information on a display section for image display to guide image capture from the plurality of image capture viewpoints such that the reference image capture viewpoint is positioned at the center of the plurality of image capture viewpoints.
